(19) United States
(12) Patent Application Publication
(10) Pub. No.: US 2007/0212207 A1
(43) Pub. Date: Sep. 13, 2007

(54) Bolt-on spill guard for buckets

(75) Inventor: Thomas Nicholas Gust, Dubuque, IA (US)

Correspondence Address: FONDUNGALLAH KIGHAM & ESSIEN, LLC, 2499 RICE STREET, SUITE 236, SAINT PAUL, MN, 55113, US

(73) Assignee: Deere & Company, Moline, IL (US)

(21) Appl. No.: 11/372,760

(22) Filed: Mar. 10, 2006

(51) Int. Cl. B66C 23/00

(52) U.S. Cl. 414/722; 37/444

(57) ABSTRACT

A spill guard for a power loader bucket having a bottom lift wall, a rear lift wall extending outwardly and forwardly from the bottom lift wall, and side walls. The spill guard is preferably adapted for operably connecting to the top edge of a rear lift wall of the power loader bucket without welding. The spill guard extends outwardly from the top of the rear lift wall. Also disclosed is a spill guard kit suitable for removably or operably connecting to the top edge of a power loader bucket. The method of connecting the spill guard of the present invention is also disclosed.

### BACKGROUND

Power loaders are typically provided with buckets having sides with a bottom and rear walls. These buckets may have raised edges that extend upwardly from the rear wall of the buckets. In most instances, the edges of the buckets are of such height that as the bucket becomes fully loaded with material, or upon a fully loaded bucket being rolled back, the edges will permit material in the bucket to pass out of or spill from the bucket over the edges. Thus, a power loader operator may be restricted in that amount of material to load in order not to overspill. It is typical for the raised top edge to be a continuation of the rear wall.

In some instances, the edge of the bucket may include posts and a plurality of horizontal louvers arranged at right angles to the post and at right angles to a plane containing the posts. This structure may offer the operator an opportunity to view the material loaded in order to avoid overfilling the bucket and creating spillage of material from the bucket over the rear edge since this material can fall upon the vehicle frame, the arms and the cab causing damage. It is also typical that installation of these edges or louvers involves employing a certified welder to permanently couple the edges to the buckets. It is a practice to provide bracing or framing along the top edge of the bucket to ensure the transverse rigidity or integrity of that top edge.

The need for a spill guard that increases the capacity of a power loader bucket and prevents undue spillage is known. Also having a spill guard that does not require the extended hours to attach to the bucket and is better adapted to prevent unintended spills is still a need for operators of power loaders. This invention discloses a spill guard and a spill guard kit that are easy to install and that serve to minimize spillage of material. The method for installation is also disclosed.

### SUMMARY

The present invention provides a bucket for a power loader. The bucket preferably includes a bottom lift wall, a rear lift wall extending upwardly and forwardly from the rear edge of the bottom lift wall, a first and a second side wall with each wall connected to the ends of the bottom and rear lift walls, and a spill guard that is operably or removably connected to the bucket at the top edge of the rear lift wall. The spill guard of the present invention preferably extends outwardly from the rear lift wall, wherein the connection of the spill guard to the bucket is accomplished without welding. Preferably, the spill guard is operably connected to the rear lift wall by at least a bracket or bracket means.

The present invention also provides a power loader comprising a vehicle frame, a cab mounted on the frame for receiving an operator, and at least a loader arm extending forwardly from the frame. The loader arm preferably includes a means for raising and lowering the arm, and the bucket as described above mounted on the forward ends of the loader arm.

The present invention also provides a method for installing a spill guard on the power loader bucket of a power loader. The method includes providing a power loader having a vehicle frame, the frame including, a cab mounted on the frame for receiving an operator preferably having a loader arm extending forwardly from the frame. The loader arm including a means for raising and lowering the arms, a bucket mounted on the forward ends of the at least a loader arm, the bucket having a bottom lift wall, a rear lift wall extending upwardly and forwardly from the rear edge of the bottom lift wall, a first and a second side wall, each connected to the ends of the bottom and rear lift walls. The method also includes providing a spill guard for connection to the bucket at the top edge of the rear lift wall without welding.

The present invention also provides a spill guard kit for a power loader bucket comprising a sheet with at least a post for attaching at least a bracket or bracket means thereto and further adapted for operably connecting to at least a brace on a rear lift wall of the power loader bucket, wherein the spill guard kit is connected to the power loader bucket without welding.

The present invention also discloses a method for installing a spill guard kit of the present invention on a power loader bucket without welding.

These and other aspects of the present invention will become apparent from the disclosures together with the included drawings.

### BRIEF DESCRIPTION OF THE DRAWINGS

FIG. 1 is a schematic isometric view of a power loader according to the present invention.

FIG. 2 is a rear perspective view of the power loader bucket according to the present invention.

FIG. 3 is a perspective and expanded views of the spill guard kit and a top section of the bucket according to the present invention.

### DETAILED DESCRIPTION

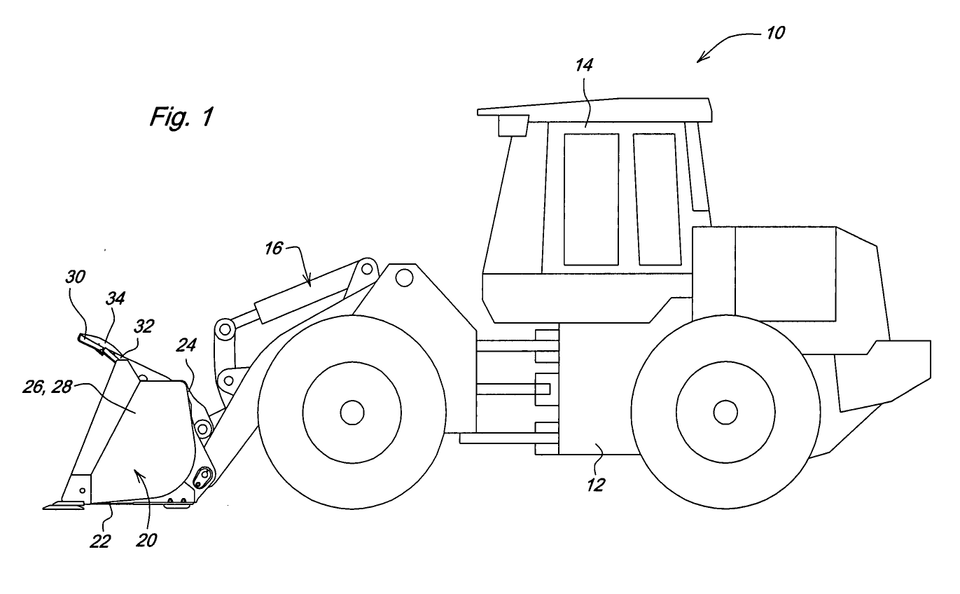

FIGS. 1-3 illustrates embodiments of the present invention. In particular, FIG. 1 illustrates a preferred embodiment of the present invention in the form of a power loader 10 having a vehicle frame 12 with a cab 14 mounted thereon, and at least a loader arm 16 that extends forwardly from the vehicle frame 12. The loader arm 16 preferably includes a means for raising and lowering the arm 16, and preferably has a bucket 20 mounted on the forward ends of the at least one loader arm 16. The bucket 20 of the present invention has a bottom lift wall 22, and a rear lift wall 24 extending upwardly and forwardly from the rear edge of the bottom lift wall 22. The bucket 20 of the present invention also includes a first side wall 26 and a second side wall 28 (one side shown); these side walls connected to the ends of the bottom lift wall 22 and the rear lift wall 24. Preferably and operably connected to the top edge of the rear lift wall 24 is a spill guard 30. The spill guard 30 of the present invention is preferably adapted for connecting to the top edge 32 of the rear lift wall 24, and preferably comprises at least a bracket or bracket means 34 that extends downwardly from the bottom portion of the spill guard 30.

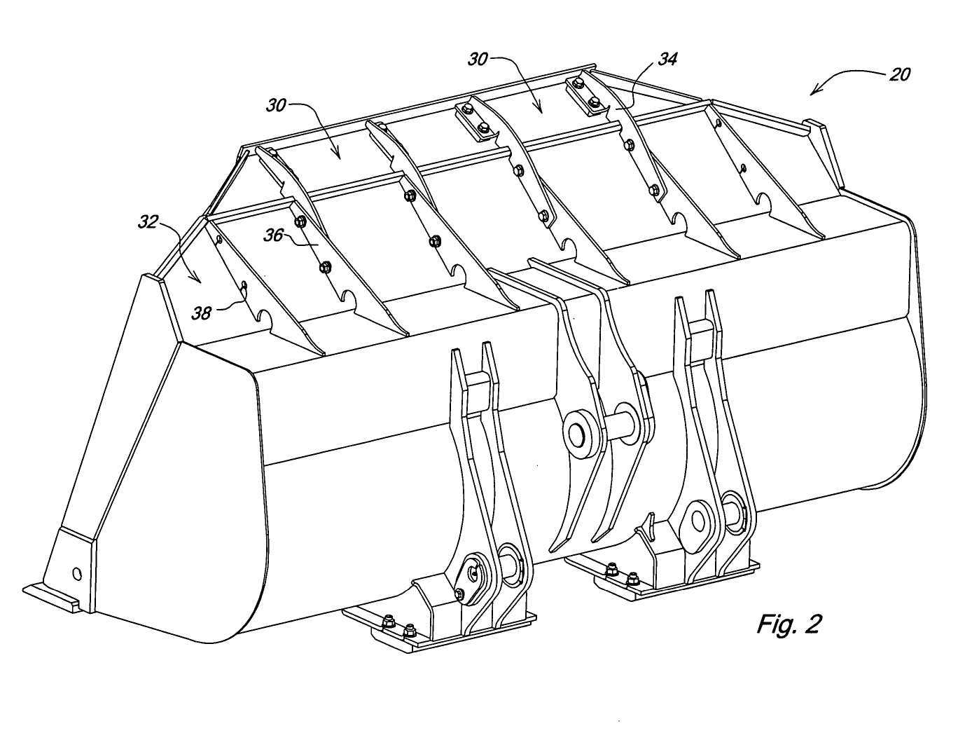

FIG. 2 is an embodiment of the power loader bucket 20 having the spill guard 30 of the present invention. The bucket 20 is preferably equipped with at least a brace 36 that may serve as support for the bucket 20 and connecting the tope edge of the bucket 32 with the bottom rear lift wall 24, as illustrated in the exemplar. The brace 36 preferably includes at least an aperture 38 adapted for operably or removably connecting the spill guard 30 to the top edge of the rear lift wall 32 according to the present invention. Thus, the power loader bucket 20 of the present invention preferably comprises a bottom lift wall 22, a rear lift wall 24 with a spill guard 30 operably connected to its top edge 32. The spill guard 30 of the present invention is preferably equipped with at least a bracket or bracket means 34 having at least an aperture 42 such that attachment means that may include nuts, bolts, screws, clamps, and the like, may be utilized to operably connect the spill guard 30 to the top edge of the rear lift wall 32. It is preferable that the aperture 42 of the bracket or bracket means 34 of the spill guard 30 is adaptable to match the aperture 38 of the brace 36 connected to the top edge 32 of the bucket 20.

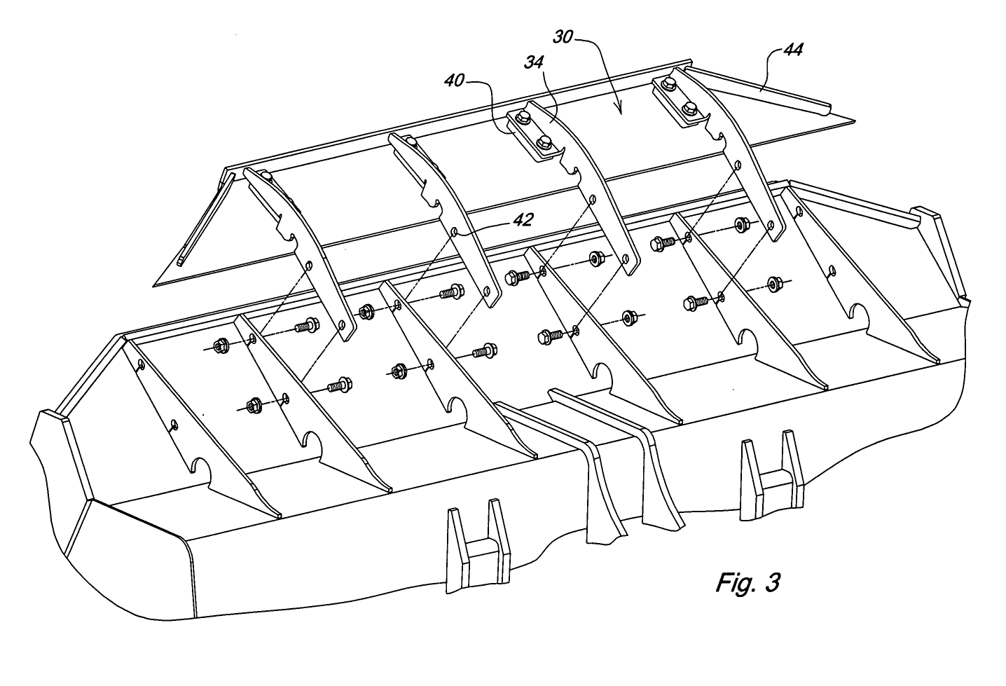

FIG. 3 illustrates an expanded view of the spill guard 30 of the present invention and the top edge of the power loader bucket 32. The spill guard 30 preferably includes at least a post 40 for attaching the bracket 34 that is adaptable for operably connecting the spill guard 30 with the top edge 32 of the bucket 20. The bracket or bracket means 34 may also be welded, or otherwise attached to the body of the spill guard 30. The spill guard 30 of the present invention may include a side shield 44. The side shield 44 may be usable to prevent further spillage from the bucket. As shown in FIG. 3, the side shield of the present invention may be a lip on the side edges of the spill guard 30.

The spill guard 30 of the present invention may be operably attached to a bucket of a new power loader during manufacture and assembly of the power loader or as an after-market addition to a used power loader. As a benefit of the present invention, the spill guard 30 may be offered as a kit that is usable to upgrade existing power loaders in the market place as part of this invention. This kit effectively and preferably obviates the need to employ the services of professionals such as welders to attach spill guards as is currently obtainable. Also, due to the size of a typical power loader, the difficulty in transporting them back to the welder's shop is eliminated by having a spill guard kit such as disclosed in the present invention that is adapted for installation on equipments in the market place after manufacture.

It is noteworthy that some of the structures described in the present invention in single terms, such as bracket, brace, loader arm, and the like, are for illustration only. More of these structures may be needed to effectively carry out this invention as disclosed.

Having thus described the preferred embodiments of the present invention, those of skill in the art will readily appreciate that the teachings found herein may be applied to yet other embodiments.

1. A bucket for a power loader comprising:
a bottom lift wall;
a rear lift wall extending upwardly and forwardly from the rear edge of the bottom lift wall;
a first and a second side wall, each connected to the ends of the bottom and rear lift walls; and
a spill guard operably connected to the bucket at the top edge of the rear lift wall and extending outwardly from the rear lift wall, wherein the connection of the spill guard to the bucket is accomplished without welding.

2. The bucket of claim 1, wherein the spill guard is operably connected to the rear lift wall by at least a bracket.

3. A power loader comprising:
a vehicle frame;
a cab mounted on the frame for receiving an operator;
at least a loader arm extending forwardly from the frame, the loader arm including a means for raising and lowering the arm;
a bucket mounted on the forward ends of the loader arm, the bucket having a bottom lift wall;
a rear lift wall extending upwardly and forwardly from the rear edge of the bottom lift wall;
a first and a second side wall, each connected to the ends of the bottom and rear lift walls; and
a spill guard operably connected to the bucket at the top edge of the rear lift wall and extending outwardly from the rear lift wall, wherein the connection of the spill guard to the bucket is accomplished without welding.

4. The power loader of claim 3, wherein the spill guard is operably connected to the rear lift wall by at least a bracket.

5. A method for installing a spill guard on a power loader comprising:
providing a vehicle frame, the frame including;
a cab mounted on the frame for receiving an operator;
at least a loader arm extending forwardly from the frame, the loader arm including a means for raising and lowering the arms;
a bucket mounted on the forward ends of the at least a loader arm, the bucket having a bottom lift wall;
a rear lift wall extending upwardly and forwardly from the rear edge of the bottom lift wall;
a first and a second side wall, each connected to the ends of the bottom and rear lift walls;
providing a spill guard; and
operably connecting the spill guard to the bucket at the top edge of the rear lift wall, wherein the connection of the spill guard to the bucket is accomplished without welding.

6. The method of claim 5, wherein the spill guard is connected to the rear lift wall by at least a bracket.

7. A spill guard kit for a power loader bucket comprising:
a sheet with at least a post, said post having at least a bracket attached thereto and adapted for operably connecting to an aperture in a brace on a rear lift wall of the power loader bucket, wherein the sheet is adapted for connection to the power loader bucket without welding.

8. A method for installing a spill guard kit on a bucket comprising:
providing a bucket having a bottom lift wall, a rear lift wall extending upwardly and forwardly from the edge of the bottom lift wall, and a first and second side wall, each connected to the ends of the bottom and rear lift walls;
providing a spill guard kit, the kit further comprising a sheet with at least a post, the post having at least a bracket attached thereto and adapted for operably connecting to at least an aperture in a brace on a rear lift wall of the bucket, wherein the sheet is connected to the top edge of the rear lift wall of the bucket without welding.
